(19) United States
(12) Patent Application Publication
(10) Pub. No.: US 2004/0093952 A1
(43) Pub. Date: May 20, 2004

(54) Electronic pressure transducer

(76) Inventor: Spencer Eisenbarth, Coto de Caza, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/715,154

(22) Filed: Nov. 17, 2003

Related U.S. Application Data
(60) Provisional application No. 60/427,087, filed on Nov. 15, 2002.

(51) Int. Cl. G01L 7/04

(52) U.S. Cl. 73/732

(57) ABSTRACT

A pressure transducer comprises a Bourdon tube, a magnetic component and a GMR sensor. The Bourdon tube comprises a base, a tube attached to the base and a mechanical linkage converting movement of the tube into rotational movement of a shaft. The magnetic component is mounted to the shaft. The magnetic component emits a magnetic field. The GMR sensor is mounted relative to the magnetic component and is arranged to detect rotational movement of the magnetic component. The GMR sensor is adapted to output an electrical signal representative of rotation of said magnetic component.

### PRIORITY TO RELATED APPLICATION

The present application claims the priority benefit under 35 U.S.C. § 119(e) of U.S. Provisional Application No. 60/427,087, filed Nov. 15, 2002, entitled “Electronic Pressure Transducer,” which is hereby expressly incorporated by reference in its entirety.

### BACKGROUND OF THE INVENTION

1. Field of the Invention

The present invention generally relates to all applications, industrial, process and automotive, which require the electronic measurement of the operating pressure of fluids. More particularly, the present invention relates to an improved electronic pressure transducer arrangement that is adapted for use in automotive applications.

2. Description of the Related Art

The need to measure the operating pressure of fluids is universal to all industrial, process, and automotive applications. In the simplest of these applications, a direct mechanical readout is sufficient. In the vast majority of the applications, however, the measured pressure is used by automated controls and/or monitored at a remote location. In these applications, the measured pressure must be converted to an electronic signal before it can be used. The devices utilized to perform this conversion are called electronic pressure transducers.

The existing technology for these devices can be divided into two broad categories generally based on cost and performance. The two categories are 1) Low Cost/Low Accuracy transducers and 2) High Cost/High Accuracy transducers.

Devices in the first category typically utilize the same mechanical devices used in the direct readout instruments, such as a Bourdon tubes or diaphragms, which exhibit large changes in position as pressure is applied. The change in position is then measured by mechanically connecting the device to a standard electric potentiometer. The output of the potentiometer is proportional to the measured pressure. These devices are very simple and as the components utilized to make the devices are inexpensive, they are low in cost. The devices, however, due to the mechanical linkage and drag of the potentiometer devices are limited in reliability and accuracy. Typical accuracies of these devices can range from +/−5 percent to +/−20 percent of full-scale reading.

Devices in the second category replace the mechanical linkage and potentiometers with semiconductor technology to directly measure the mechanical movement of the pressure element. These devices offer many advantages including small size, high reliability, and high accuracy. Typical accuracies of these devices range from 0.25% to 1% of full-scale readings. These devices, however, are considerably more expensive than the devices in the first category. Costs range from a low of 5 to 10 times the cost of the devices in the first category to as much as several hundred times the cost for extremely accurate versions.

The accuracy requirements of many applications, however, fall in the area between the two categories above. In many applications, +/−5 percent accuracy is insufficient while +/−0.5 percent is more than adequate. In these situations, the user must compromise either in accuracy or in cost. In many cases, such as the automotive aftermarket, the more expensive high accuracy transducers are not an option due to the expense. It is clear in this instance a medium cost medium accuracy electronic pressure transducer would be of significant value.

### SUMMARY OF THE INVENTION

Accordingly, one object of the present invention is to construct a medium accuracy electronic pressure transducer utilizing low cost components. Two embodiments arranged and configured in accordance with certain features, aspects and advantages of the present invention are illustrated. The first embodiment provides an electronic output (either analog or digital) proportional to the measured pressure. The second embodiment provides the same electronic output with the addition of a visual mechanical indication of the measured pressure.

One embodiment combines a conventional mechanical Bourdon tube pressure element, such as those found in standard mechanical gauges, a small magnet, and a giant magneto resistive sensor (GMR) with suitable signal conditioning electronics. The conventional Bourdon tube converts the fluid pressure via a mechanical linkage into a rotary position of a small shaft. In standard mechanical gauge configurations, an indicator needle is attached to the end of this shaft. The rotary position of the needle generally indicates the pressure applied to the Bourdon tube. Advantageously, Bourdon tube technology is well developed and highly suited for many measurement applications. The devices are also very low in cost.

In one configuration of an embodiment the present invention, the needle on the Bourdon tube is replaced with a small magnet or magnets that are used to generate a magnetic field, the direction of which indicates the rotary position of the Bourdon tube. In another configuration of an embodiment the present invention, the indicator needle remains on the rotary shaft of the Bourdon tube; one or more small magnets are attached to the opposite end of the rotating shaft to generate a magnetic field as described above. This configuration provides both a mechanical readout and an electronic output such as would be useful in gauges used in conjunction with data acquisition and recording instruments, for example.

A small circuit board containing a GMR sensor and suitable signal conditioning electronics can be placed near the small magnet or magnets in an orientation generally perpendicular to the axis of rotation of the magnets. The GMR sensor converts the direction of the magnetic field into a voltage or voltages generally proportional to the rotational position/pressure measured by the device. Suitable signal conditioning circuitry then can be used such that the voltage or voltages can be used to determine the applied pressure of the fluid, for example. The GMR sensor is a non-contacting sensor and, therefore, the mechanical drag and loss of accuracy typical with low cost transducer applications is substantially reduced.

The GMR sensor generally measures only the direction of the magnetic field. Output of the sensor is independent of field strength within a large saturation window. These characteristics eliminate the need for close production tolerances. Depending on magnet size, production tolerances of greater than 0.25 inches can be tolerated with no virtually change in output of the device. This significantly reduces the manufacturing cost versus other technologies. Furthermore, GMR sensor configurations can be utilized which virtually eliminate the need for temperature compensation.

Advantageously, the Bourdon tube/GMR sensor combination can be configured to measure a full 360 degrees of rotation. Of course, other ranges of rotation also can result. Other sensing arrangements are limited to small movements. Thus, the sensitivity and accuracy of the Bourdon tube can be greatly improved.

### BRIEF DESCRIPTION OF THE DRAWINGS

These and other features, aspects and advantages of the present invention will now be described with reference to drawings of more than one preferred embodiment, which embodiments are intended to illustrate and not to limit the present invention. The figures comprise 13 drawings.

FIG. 1 is a partial view of a Bourdon tube and magnet assembly showing a preferred relative location of a GMR sensor versus an axis of rotation of the magnet. As shown, this configuration represents an electrical output type of configuration.

FIG. 2 is a partial view of a Bourdon tube and magnet assembly showing an attachment of a printed circuit board assembly with the GMR sensor to a main body of the Bourdon tube.

FIG. 3 is a partial view of a Bourdon tube and magnet assembly showing a preferred relative location of a GMR sensor versus an axis of rotation of the magnet. In addition, this view shows the addition of a mechanical indicator needle to the Bourdon tube, which needle provides a visual indication of a measured pressure.

FIG. 4 is a front view of the visual indicator of FIG. 3 showing the mechanical readout capabilities.

FIG. 5 is a partial view of a Bourdon tube and magnet assembly showing a preferred relative location of a GMR sensor versus an axis of rotation of the magnet. This view illustrates an alternate magnet configuration.

FIG. 6 is a graph of the output of a GMR sensor versus magnetic field strength.

FIG. 7 is a graph of the relative strength of the GMR effect versus lateral position of the GMR sensor relative to the magnet.

FIG. 8 is a schematic view of two potential bridge configurations of the GMR sensor.

FIG. 9 is a schematic diagram of the GMR sensor and preferred signal conditioning elements.

FIG. 10 is a view of a completed dual transducer element in a housing.

FIG. 11 is a perspective view of a portion of the housing of FIG. 10 showing two Bourdon tubes mounted therein.

FIG. 12 is a perspective view of another portion of the housing of FIG. 10 showing the GMR sensors mounted therein.

FIG. 13 is a perspective view of a baffle plate that separates the two portions of the housing of FIG. 10 in liquid-filled applications.

### DETAILED DESCRIPTION OF THE PREFERRED EMBODIMENT

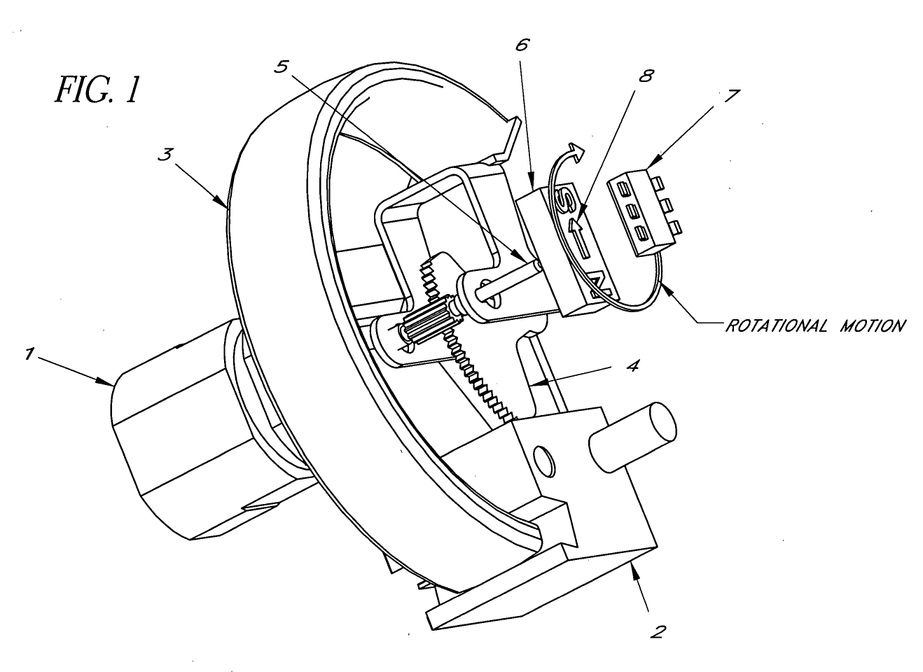

With reference initially to FIG. 1, an embodiment of a transducer assembly that is arranged and configured in accordance with certain features, aspects and advantages of the present invention is shown. The illustrated embodiment generally comprises a Bourdon tube assembly 1, a small bar magnet 6 and a GMR (giant magneto-resistive sensor) 7.

Bourdon tubes are commonly used in pressure gauges, which are used in the measurement of pressures. A hollow Bourdon tube of a pressure gauge generally is somewhat oval in cross-section. When the pressure inside the tube increases, the tube's oval walls are distorted and the tube's cross-section becomes slightly more circular. However, the tube is wrapped in a coil and as its walls become more circular, the tube uncoils slightly. The amount of uncoiling that occurs is almost exactly proportional to the pressure inside the Bourdon tube. As the tube uncoils, its motion activates a rack-and-pinion gear system that turns the needle on the pressure dial of the gauge.

The illustrated Bourdon tube assembly generally comprises a base 2, which includes a mechanical connection to any external body of fluid, the pressure of which is to be measured. In some embodiments, the body of fluid can be a liquid or a gas. The base 2 preferably includes a fitting 20 with which the Bourdon tube assembly 1 can be connected to a conduit or pipe that is in communication with the body of fluid. In one embodiment, the base 2 includes an integrally formed nipple with threading to which a conduit can be connected. Other types of fittings also can be used to connect the base 2 to the source of pressurized fluids.

As described above, a curved hollow tube element 3 is connected to the base with internal passageways to allow the measured fluid to communicate with the internal cavity of the tube element 3. The pressure of the fluid in the cavity causes the tube element 3 to straighten causing a movement of the end of the tube generally proportional to the pressure measured. A mechanical linkage and gear mechanism 4 (e.g., a rack and pinion arrangement)(that is connected to the end of the tube element 3 and to the base 2 translates this movement into a rotational movement of a shaft 5.

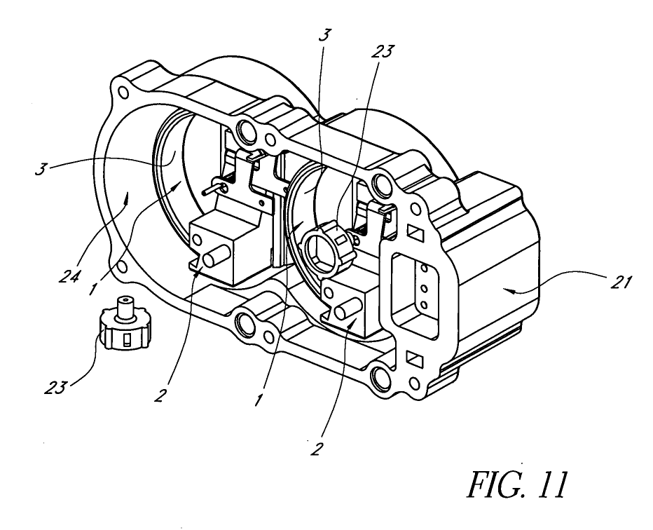

Rather than a commonly used needle, a small bar magnet 6 is attached to the end of the illustrated shaft 5 such that the magnetic field lines generated at the face of the magnet 6 are generally perpendicular to the axis of the shaft 5 as shown by arrow 8. In some embodiments, such as those shown in FIG. 11, a magnetic basket 23 can be used in which the magnet 6 or magnets 6 can be mounted. The direction of the magnetic field lines indicates the angle of rotation of the shaft 5. The magnet 6 can be any suitable magnetic member. Preferably, the magnet 6 is sufficiently strong to overcome any external magnetic field that may be encountered during use in the destined application. For instance, when installed in an automobile, preferably the magnet 6 is sufficiently strong to overcome any other external magnetic field that may be present in or around the associated GMR sensor 7.

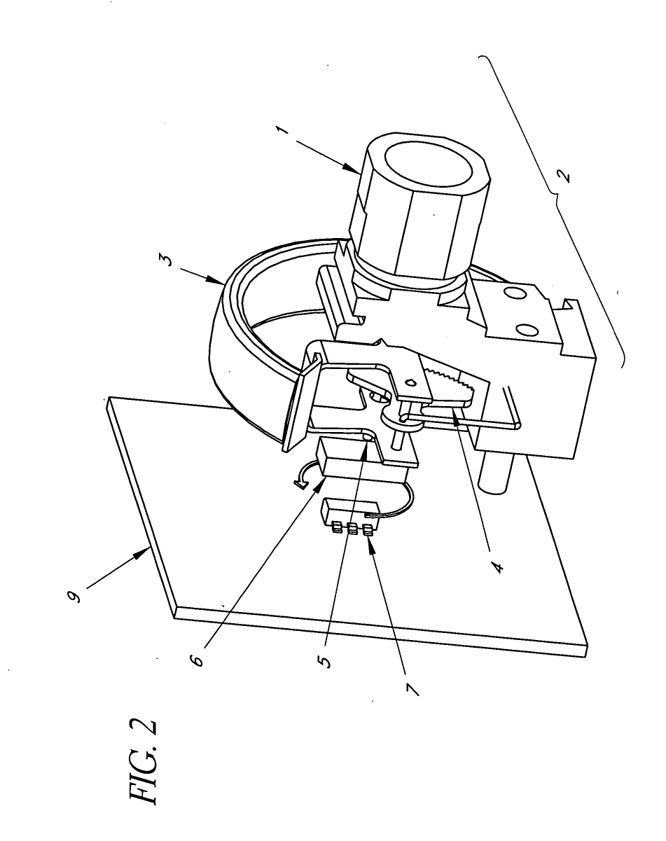

With reference to FIG. 1 and FIG. 2, the GMR sensor 7 can be mounted to a small PCB (printed circuit board) 9. The GMR sensor 7 preferably is mounted relative to the magnet 6 such that its internal sensing elements are generally parallel to the magnetic field generated by magnet 6 and such that the axis of the shaft 5 passes through about the center of the sensing elements of the sensor at the median measured pressure. The PCB 9 can be mounted either directly to the base 2 of the Bourdon tube 1 (as shown in FIG. 2) or to an external housing (as described below) in such a manner that the position of the GMR sensor 7 is generally fixed relative to the base 2 of the Bourdon tube 1. It has been determined that the device can be disposed to any side of an ideal location relative to the magnet 6 by as much as about 0.25 inch. In some arrangements, this distance can range from about 0.4 inch to 0.0 inch. Thus, positioning of the GMR sensor 7 can be done with fairly liberal tolerances, which reduces manufacturing costs.

The GMR sensor 7 generates an electrical output that is generally proportional to the direction of the magnet field such that the output will vary with the pressure of the fluid applied. Electronic circuitry on the PCB 9 connected to the GMR sensor 7 can condition the output in any suitable manner either for direct readout of the pressure and/or for an interface to a microprocessor.

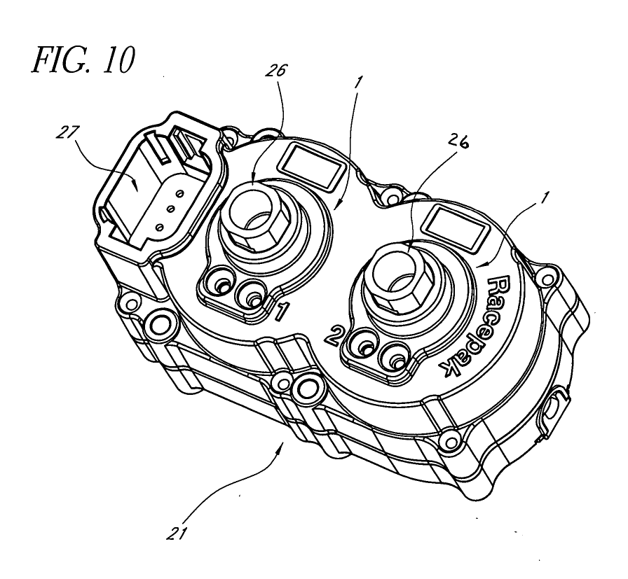

The transducer assembly described above can be packaged with any additional electronics, such as a microprocessor for interfacing to a digital communication bus and/or connectors inside an external housing. An example of two transducer assemblies 1 packaged in a single housing 21 is shown in FIG. 10. As shown, a pair of fittings 26 extend outward and provide ports for connecting to the pressurized lines that are in communication with the fluid being sensed. In addition, an electrical connector 27 is provide that can be used to connect to a data bus or the like.

As indicated above, some separation between the magnet 6 and the GMR sensor 7 can be tolerated. Accordingly, it is possible to position the magnet 6 and the Bourdon tube 1 within a liquid-tight chamber that can be filled with liquid such that the effect of vibratory energy on the Bourdon tube 1 can be reduced. This is particularly advantageous for automotive applications, and even more advantageous for assemblies used in automobile racing, for instance.

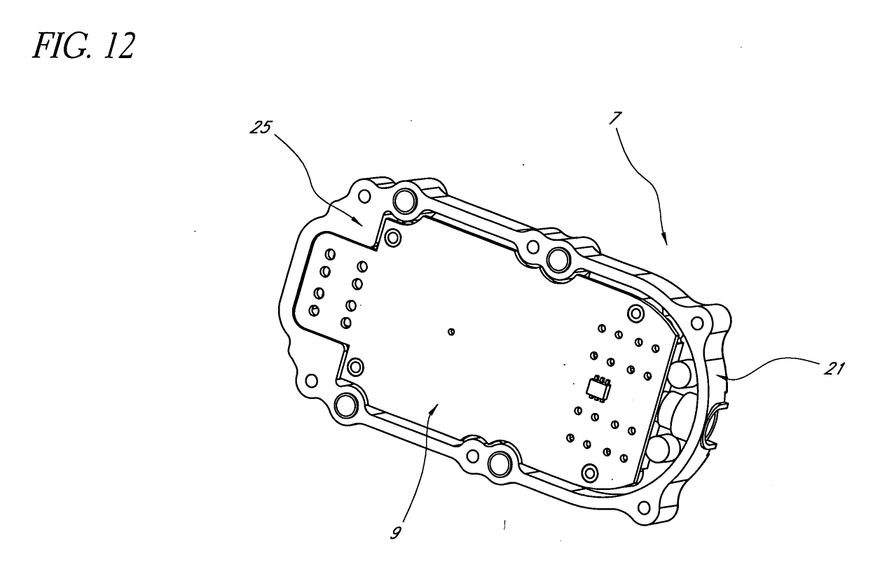

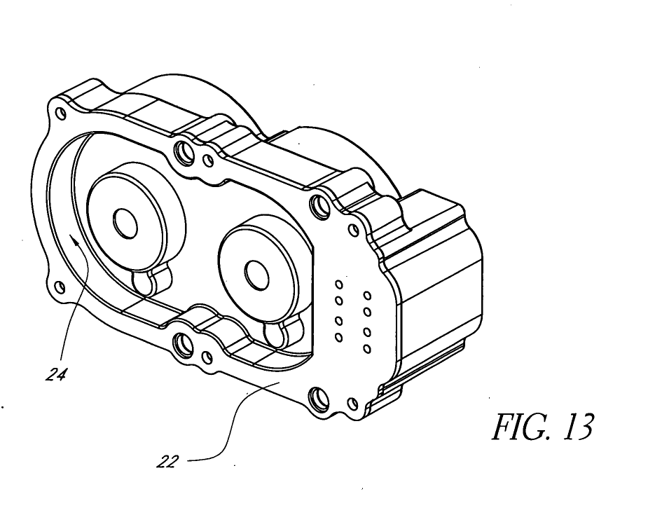

With reference to FIGS. 11-13, in liquid filled applications, a baffle plate 22 can be mounted within the housing 21 to reduce or eliminate leakage of the fluid filling the portion 24 of the housing containing the mechanical portion of the arrangement into the portion 25 of the housing containing the electrical portion of the arrangement. Thus, the baffle plate 22 can be mounted between a first portion 24 of the housing 21 and a second portion 25 of the housing 21 where the first portion of the housing contains substantially all of the mechanical components (e.g., the Bourdon tube assembly, the fittings, etc.) and the second portion of the housing contains substantially all of the electrical components (e.g., the GMR, the PCB, etc.). The electrical connector 27, while extending through a portion of the first portion 24 of the housing 25, advantageously is isolated from the fluid containing chamber defined by the first portion 24 and is sealed by the baffle 22. The PCB 9 is in electrical communication with the connector 27 through the baffle 22.

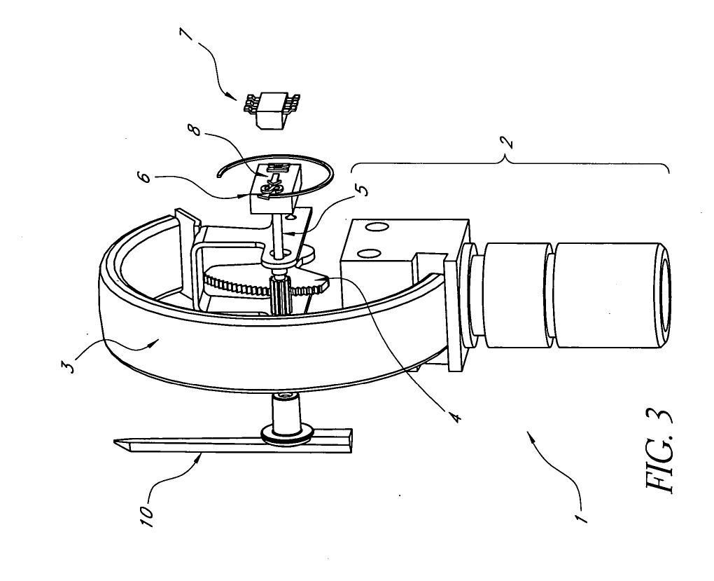

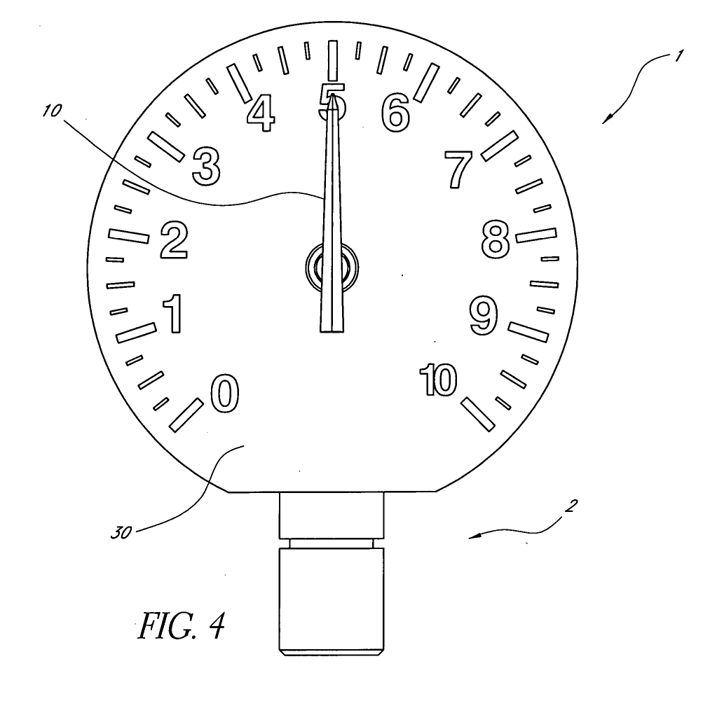

As discussed above, several different arrangements of the transducer assembly can be constructed. FIG. 3 illustrates a second arrangement that is arranged and configured in accordance with certain features, aspects and advantages of the present invention. The arrangement of FIG. 3 generally provides a mechanical readout as well as an electrical readout. In this configuration, a gauge needle 10 is connected to the end opposite the magnet 6 on the shaft 5. FIG. 4 illustrates a typical dial face 30 and the needle 10 which are similar to those used in conventional gauges. The needle 10 in the illustrated arrangement directly indicates the measured pressure in the same manner as any conventional Bourdon tube gauge; however, the magnet 6 provides a magnetic field that can be used in the manners described above such that a more accurate electronic readout can be provided. Thus, the arrangement of FIG. 3 provides both a mechanical output and an electrical output.

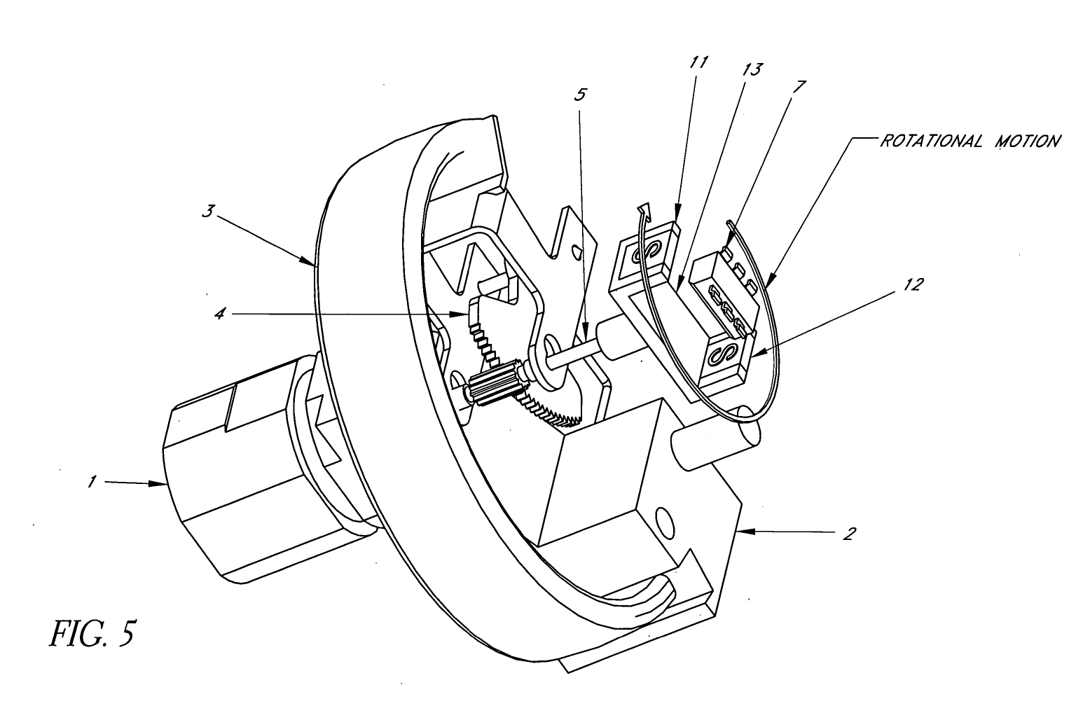

In addition to different Bourdon tube configurations, various gauge configurations and magnetic orientations can be used to generate the magnetic fields detected by the GMR sensor. FIG. 5 illustrates an alternate magnet configuration. In this case, the bar magnet 6 (see FIG. 1) is replaced with two magnets 11, 12 that are mounted in a non magnetic holder 13 and that are placed on an end of the rotary shaft 5. The magnets 11, 12 preferably are inserted into the holder 13 such that the facing surfaces of the magnets 11, 12 contain opposite poles (one a north pole one a south pole). This configuration advantageously generates a straight magnetic field between the magnets 11, 12 generally perpendicular to the axis of rotation of shaft 5 in much the same manner as the bar magnet 6 (see FIG. 1).

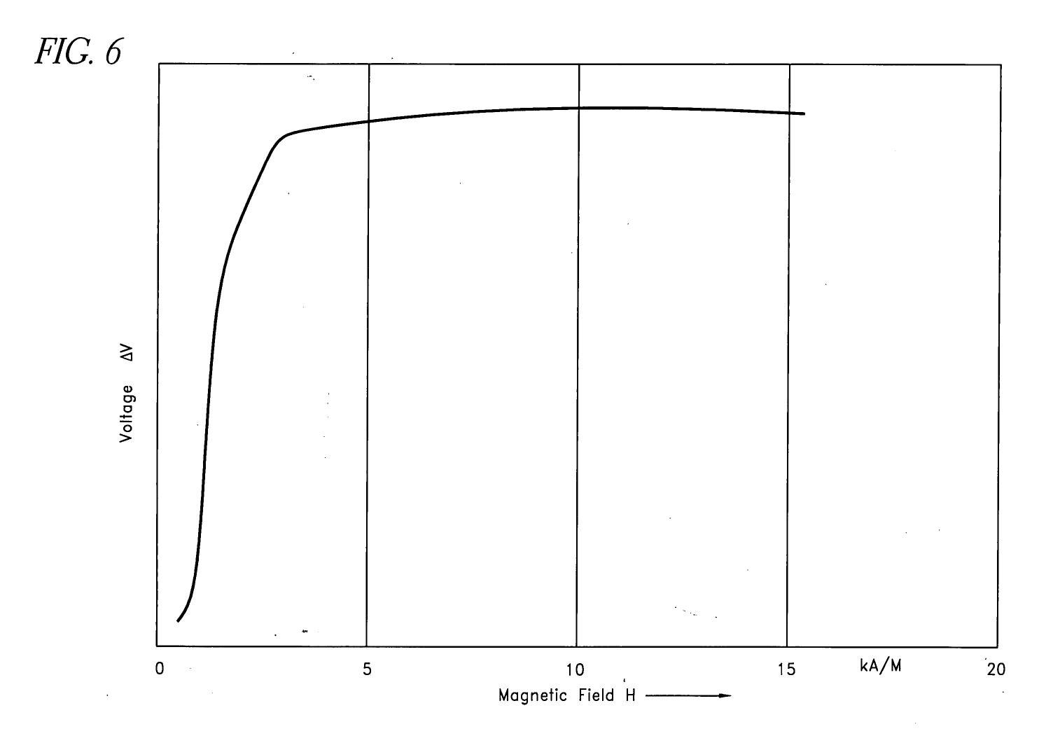

The use of the GMR sensor is desired because it is suited for this application due to characteristics it offers. For instance, the output from the GMR sensor is generally constant over a wide range of applied magnetic field strength, as illustrated in FIG. 6. This eliminates the need to match magnets and sensors for a specific pressure transducer assembly. As long as the field strength of the magnet relative to the sensor falls within the large saturation window of the sensor 7, any magnet or combination of magnets can be used with any GMRsensor 7, which greatly simplifies the manufacturing process.

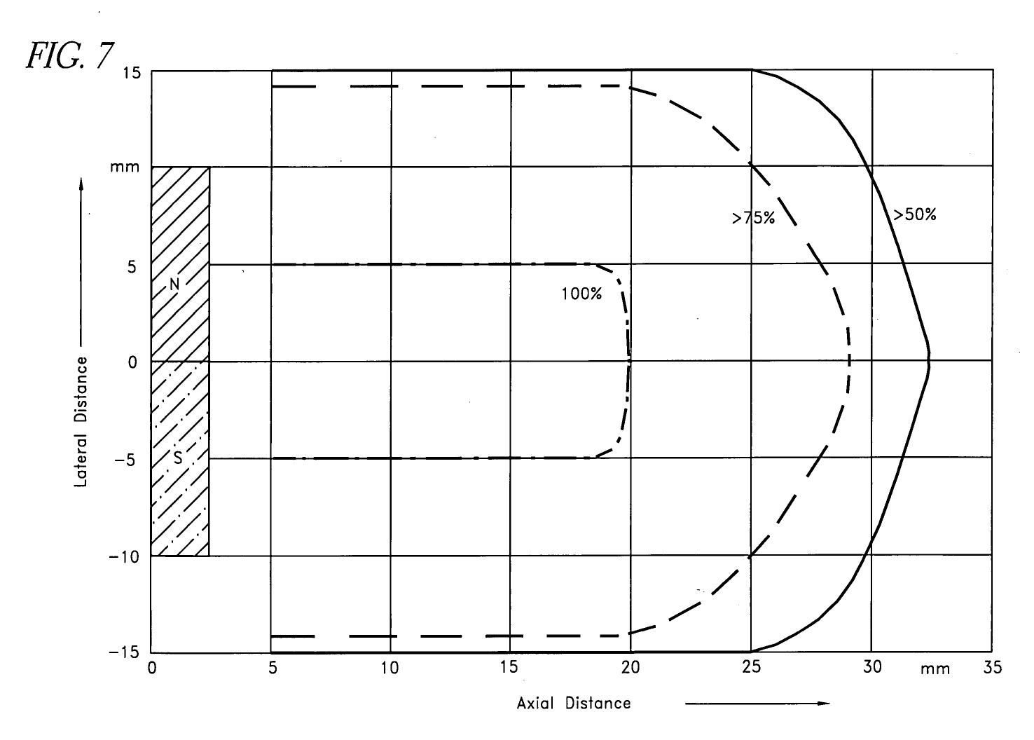

In addition, because the GMR sensor 7 advantageously measures the direction of magnetic field, a large air gap and spatial assembly tolerance results with limited, if any, substantive change in sensor output. For instance, one example of these spatial tolerances and air gaps is illustrated in FIG. 7. Thus, employing the GMR sensor 7 substantially eliminates the need for time-consuming intricate alignment adjustments during the manufacturing process such as are typically needed to compensate for the wide production tolerances of the Bourdon tube assemblies 1, which ultimately reduces the cost of the final product.

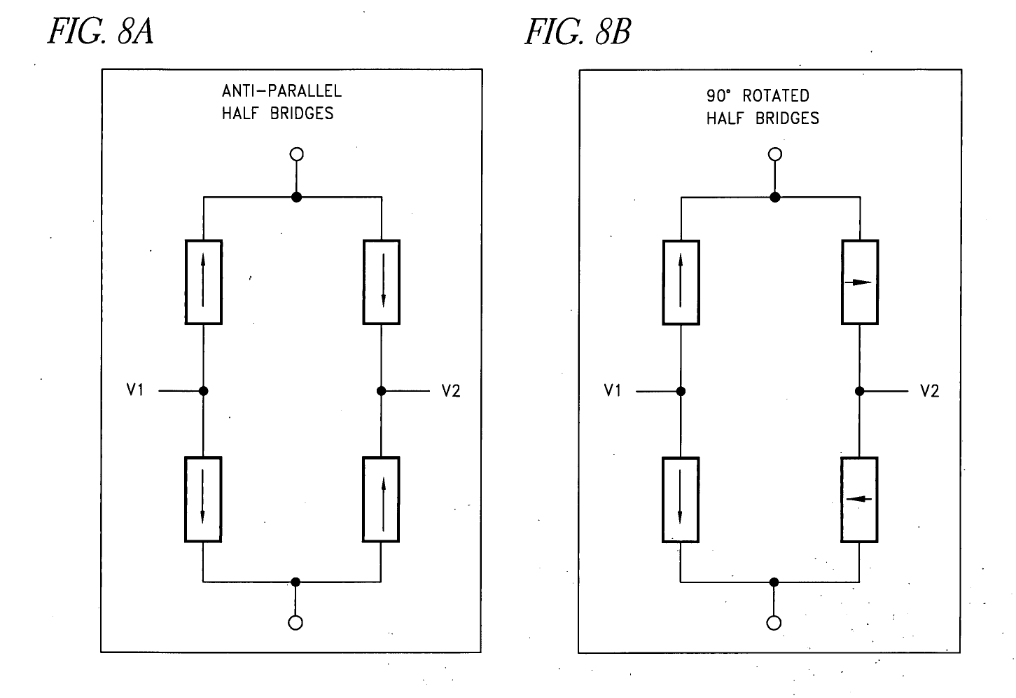

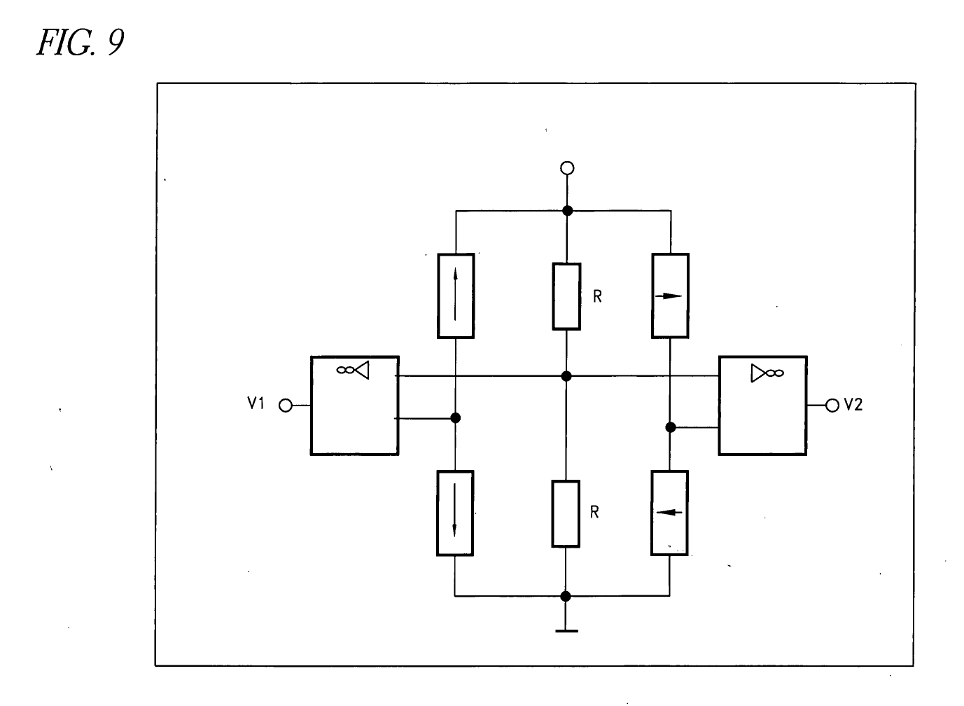

Electronics useful with GMR sensors 7 can take any of a number of configurations. In one arrangement, such as that illustrated in FIG. 9, a full bridge configuration consisting of 4 magneto resistive elements per sensor is utilized. At least two different bridge variations can be utilized depending upon the application. With reference to FIG. 8, one suitable arrangement employs a bridge consisting of two antiparallel half bridges. This configuration is best for those applications where a direct electric output is required. Another suitable arrangement employs a full bridge consisting of two half bridges in which the half bridges are rotated either 45 or 90 degrees to one another. This configuration is best used when a microprocessor is required for other functions such as transmission of the measured data via digital protocols.

The arrangement using 90 degree rotated half bridges is preferred because it better takes advantage of the match between the characteristics of the Bourdon tube and the sensor. For instance, a full 360-degree measurement range can be used to increase the sensitivity/accuracy of the Bourdon tube. In addition, the need for temperature compensation can be greatly reduced or eliminated, which results in simpler signal conditioning electronics. Temperature compensation can be greatly reduced or eliminated because the angle of rotation measured by the device is proportional to the ratio of the voltage measured by the two bridges. Because the temperature sensitivities of both half bridges are the same, the temperature effects are cancelled.

With reference to FIG. 2, either no signal conditioning is required on PCB 9 or two resistors and a simple differential amplifier can be used, as illustrated in FIG. 9. Which PCB is used depends on the capabilities of the microprocessor used. In both of these cases, the measured voltages, V1 and V2, are generally proportional to the sine and the cosine of the measured angle respectively and are used as described below to compute the angle of rotation and in turn the pressure measured by the device.

As stated above, the two bridge voltages V1 and V2 are generally proportional to the sine and cosine of the measured angle. Before they can be utilized to calculate the measured angle, they preferably are normalized to correct for slight variances in the four elements which make up the bridge. These variances may show as a zero offset and an amplitude difference between the two bridge voltages V1 and V2.

The information used to normalize the two bridges can easily be found by measuring the bridge voltages V1 and V2 while rotating a magnet (positioned as described above) over the bridge through a 360 degree arc. This calibration process can be accomplished prior to final assembly of the transducer at the PCB level as the magnet, the GMR sensor, and/or the Bourdon tube assembly do not require matching in the preferred construction of the present invention. The field strength of the calibration magnet relative to the sensor desirably falls into the large saturation window for magnetic field strength as described above.

The three coefficients for normalizing the sensor are then calculated as follows.

V1 Offset=(V1 max reading+V1 min reading)/2

V2 Offset=(V2 max reading+V2 min reading)/2

V2 Gain=(V1 max reading−V1 min reading)/(V2 max reading−V2 min reading)

The angle of rotation at any angle as measured by the bridge voltages V1 and V2 can then be calculated by the following equation.

Measured angle=arc tan((V1−V1 Offset)/((V2−V2 Offset)*V2 Gain))

To calculate the pressure which corresponds to the measured angle two addition coefficients must be known. These are as follows:

Angle at zero pressure=the measured angle when the pressure of the fluid is at 0.

Gain Constant=Constant defined by the characteristic of the Bourdon in pressure units per degree rotation. (e.g., 3.3 PSI/degree)

The angle at zero pressure is determined by calibrating the final pressure transducer module with zero pressure applied to the device. The Gain Constant can either be determined from the design information from the Bourdon tube or via a second near full-scale pressure calibration point on the final pressure transducer module.

The measured pressure can then be calculated with the following equation:

Measured Pressure=(Measured angle−angle at zero pressure) * (Gain Constant)

In this manner, an arrangement of a pressure transducer having certain features, aspects and advantages of the present invention can be manufactured and assembled. Although the present invention has been described in terms of a certain preferred embodiments, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A pressure transducer comprising a Bourdon tube, said Bourdon tube comprising a base, a tube attached to said base and a mechanical linkage converting movement of said tube into rotational movement of a shaft, a magnetic component being mounted to said shaft, said magnetic component emitting a magnetic field, a GMR sensor mounted relative to said magnetic component and being arranged to detect rotational movement of said magnetic component, said GMR sensor being adapted to output an electrical signal representative of rotation of said magnetic component.

2. The pressure transducer of claim 1, wherein said magnetic member is a bar magnet.

3. The pressure transducer of claim 1, wherein the magnetic member comprises a non-magnetic housing.

4. The pressure transducer of claim 3, wherein said magnetic member further comprises a pair of magnets disposed within said non-magnetic housing.

5. The pressure transducer of claim 1 in combination with a fluid-tight housing, said mechanical linkage being disposed within a liquid-filled chamber in said fluid-tight housing.

6. The pressure transducer of claim 5, wherein said housing is divided into said fluid-filled chamber and a dry chamber, said GMR sensor being disposed within said dry chamber.

7. The pressure transducer of claim 1, wherein said GMR sensor is mounted to a printed circuit board.

8. The pressure transducer of claim 7, wherein said printed circuit board is mounted to said base of said Bourdon tube.

9. The pressure transducer of claim 1, wherein said GMR sensor comprises sensing elements that are mounted generally perpendicular to an axis of rotation of said magnetic component.

10. The pressure transducer of claim 1 further comprising a needle mounted to said shaft.

11. A pressure transducer comprising a Bourdon tube, said Bourdon tube comprising a base, a tube attached to said base and a mechanical linkage converting movement of said tube into rotational movement of a shaft, a magnetic component being mounted to said shaft, said magnetic component emitting a magnetic field, and a means for detecting rotational movement of said magnetic component, whereby said means outputs an electrical signal representative of rotation of said magnetic component.

12. The pressure transducer of claim 11, wherein said means comprises a GMR sensor.

13. The pressure transducer of claim 12, wherein said GMR sensor is generally perpendicular to an axis of rotation of said shaft.

14. The pressure transducer of claim 11, wherein said means is connected to a printed circuit board.

15. The pressure transducer of claim 14, wherein said printed circuit board is mounted to said base of said Bourdon tube.

16. The pressure transducer of claim 11, wherein the magnetic member comprises a non-magnetic housing.

17. The pressure transducer of claim 16, wherein the magnetic member further comprises a pair of magnets disposed within said non-magnetic housing.

18. A pressure transducer comprising a Bourdon tube, a mechanical linkage converting movement of said Bourdon tube into rotational movement, a shaft connected to said mechanical linkage whereby said shaft is rotated by said mechanical linkage, at least one magnetic component connected to said shaft, said magnetic component emitting a magnetic field, a sensor mounted relative to said magnetic component configured to detect movement of said magnetic field emitted by said magnetic component, said sensor outputting an electrical signal corresponding to movement of said magnetic component.

19. The pressure transducer of claim 18, wherein said sensor is a GMR sensor.

20. The pressure transducer of claim 19, wherein said GMR sensor comprises sensing elements that are mounted generally perpendicular to an axis of rotation of said magnetic component.

21. The pressure transducer of claim 19, wherein said GMR sensor is mounted to a printed circuit board, said printed circuit board generally perpendicular to an axis of rotation of said magnetic component.

22. The pressure transducer of claim 18, wherein the magnetic member comprising a non-magnetic housing.

23. The pressure transducer of claim 22, wherein the magnetic member further comprises a pair of magnets disposed within said non-magnetic housing.

24. The pressure transducer of claim 18, in combination with a fluid-tight housing, said mechanical linkage being disposed within a liquid-filled chamber in said fluid-tight housing.

25. A pressure transducer comprising a Bourdon tube, said Bourdon tube comprising a base, a tube attached to said base and a mechanical linkage converting movement of said tube into rotational movement of a shaft, a needle mounted to said shaft, said needle configured to rotate with said shaft to provide a mechanical output, a magnetic component being mounted to said shaft, said magnetic component emitting a magnetic field, a sensor mounted relative to said magnetic component and being arranged to detect rotational movement of said magnetic component, said sensor being adapted to output an electrical signal representative of rotation of said magnetic component.

26. The pressure transducer of claim 25, wherein said sensor is a GMR sensor.

27. The pressure transducer of claim 26, wherein said GMR sensor is mounted to a printed circuit board, said GMR sensor comprising sensing elements that are mounted generally perpendicular to an axis of rotation of said magnetic component.

28. The pressure transducer of claim 25, wherein said needle and said magnetic component are mounted on opposite ends of said shaft.

29. The pressure transducer of claim 25 in combination with a fluid-tight housing, said mechanical linkage being disposed within a liquid-filled chamber in said fluid-tight housing.

30. A method for converting pressure to an electrical signal, said method comprising the step of conversion of pressure to a rotational movement by a Bourdon tube, said Bourdon tube comprising a base, a tube attached to said base and a mechanical linkage converting movement of said tube into rotational movement of a shaft, and the step of conversion of said rotational movement to an electrical signal by a magnetic component mounted on said shaft and a GMR sensor disposed relative to said magnetic component, said magnetic component emitting a magnetic field, said GMR sensor being disposed relative to said magnetic component and being adapted to detect rotational movement of said magnetic component, and said GMR sensor being adapted to output an electrical signal representative of rotation of said magnetic component.

31. The method of claim 30, wherein said GMR sensor output electrical signal is conditioned by a printed circuit board.

32. The method of claim 31, wherein said printed circuit board conditions said GMR sensor output electrical signal for a microprocessor.

33. The method of claim 30, wherein said conversion of said rotational movement to an electrical signal further comprises conversion of GMR sensor output through a microprocessor.

34. The method of claim 30, wherein said step of conversion of pressure to a rotational movement by a Bourdon tube occurs in a fluid-tight housing, said conversion taking place within a liquid-filled chamber in said fluid-tight chamber.

35. The method of claim 34, wherein said step of conversion of said rotational movement to an electrical signal occurs in a chamber other than the liquid-filled chamber.

36. A method for converting pressure to a mechanical and electrical signal, said method comprising conversion of pressure to a rotational movement by a Bourdon tube, said Bourdon tube connected to a mechanical linkage, said mechanical linkage converting movement of said Bourdon tube into rotational movement of a shaft, said shaft comprising a needle and a magnetic component mounted thereon, said needle providing the mechanical signal, and conversion of said rotational movement to an electrical signal by said magnetic component and a GMR sensor disposed relative to said magnetic component, said magnetic component emitting a magnetic field, said GMR sensor being disposed relative to said magnetic component and being adapted to detect rotational movement of said magnetic component, and said GMR sensor being adapted to output an electrical signal representative of rotation of said magnetic component.
